(19) United States
(12) Patent Application Publication
(10) Pub. No.: US 2019/0164169 A1
(43) Pub. Date: May 30, 2019

(54) ELECTRONIC DEVICE HAVING WATERPROOF WARRANTY CONDITION JUDGMENT SYSTEM

(71) Applicants: Fu Tai Hua Industry (Shenzhen) Co., Ltd., Shenzhen (CN); HON HAI PRECISION INDUSTRY CO., LTD., New Taipei (TW)

(72) Inventor: DONG-MEI LAI, Shenzhen (CN)

(21) Appl. No.: 15/888,251

(22) Filed: Feb. 5, 2018

(30) Foreign Application Priority Data
Nov. 29, 2017 (CN) 201711225638.5

(51) Int. Cl. G06Q 30/00; G01L 5/00; G01K 13/02; G01B 5/18; G04F 10/00

(52) U.S. Cl. CPC G06Q 30/012; G01L 5/0052; G01K 2013/026; G01B 5/18; G04F 10/00; G01K 13/02

(57) ABSTRACT

An electronic device includes a sensing unit, a storage, and a processor. The sensing unit detects whether the electronic device has entered a liquid, and upon sensing that the electronic device has entered a liquid, senses a number of environmental parameters of the liquid. The processor obtains the number of environmental parameters of the liquid from the sensing unit and determines whether any of the number of environmental parameters exceed a predetermined value, and judges, when any of the number of environmental parameters exceed the predetermined value, that a waterproof warranty on the electronic device is voided.

### CROSS-REFERENCE TO RELATED APPLICATIONS

This application claims priority to Chinese Patent Application No. 201711225638.5 filed on Nov. 29, 2017, the contents of which are incorporated by reference herein.

### FIELD

The subject matter herein generally relates to electronic devices, and more particularly to an electronic device having a waterproof warranty condition judgment system.

### BACKGROUND

Electronic devices are increasingly made to be waterproof or water-resistant. The electronic devices generally have a warranty. However, it is difficult for a manufacturer to determine whether a waterproof warranty of the electronic device should be voided.

### BRIEF DESCRIPTION OF THE DRAWINGS

Implementations of the present disclosure will now be described, by way of example only, with reference to the attached figures.

FIG. 1 is a diagram of an exemplary embodiment of an electronic device.

FIG. 2 is a diagram of a waterproof warranty condition judgment system of the electronic device.

FIG. 3A and FIG. 3B are a flow chart of a method for determining whether a waterproof warranty of an electronic device is voided.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

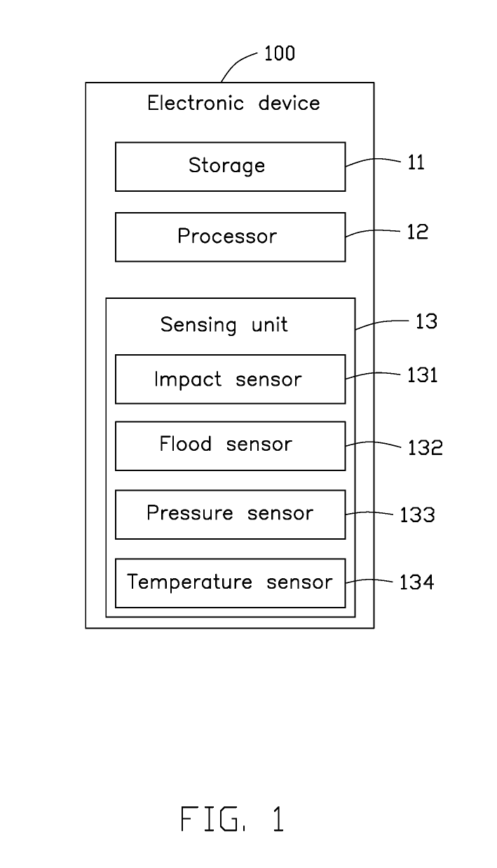

FIG. 1 illustrates an embodiment of an electronic device 100. The electronic device 100 includes a storage 11, a processor 12, and a sensing unit 13. When the electronic device 100 enters a liquid, the electronic device 100 can detect a pressure value, a temperature, and other environmental parameters at the position of the electronic device 100 in the liquid to judge whether a waterproof warranty of the electronic device 100 is voided. The liquid can be water or other liquid. For ease of description, the liquid in the present embodiment is water. The electronic device 100 can be a smart phone, a tablet computer, a personal digital assistant, a smart bracelet, a smart watch, smart glasses, or other portable or wearable devices. The electronic device 100 can include elements such as a circuit system, an audio system, an input/output port, a battery, an operating system, or the like.

The storage 11 stores data of the electronic device 100. The storage 11 can be an internal storage of the electronic device 100 or an external storage card, such as a secure digital card.

The processor 12 can be a central processing unit, a microprocessing unit, or any processing chip capable of executing data processing functions.

The sensing unit 13 includes a plurality of sensors for sensing the environmental parameters when the electronic device 100 enters water. In the present embodiment, the sensing unit 13 includes a flood sensor 132, a pressure sensor 133, and a temperature sensor 134. The flood sensor 132, the pressure sensor 133, and the temperature sensor 134 are each electrically coupled to the processor 12.

In general, if the electronic device 100 falls or is impacted by an outside force, a waterproof function of the electronic device 100 will be affected. During a process of judging whether the warranty is voided, it is first determined whether the electronic device 100 has been impacted or dropped. Thus, the electronic device 100 further includes an impact sensor 131 for sensing an acceleration of the electronic device 100, and the processor 12 can determine according to the acceleration whether the electronic device 100 is impacted by an external force or dropped. In at least one embodiment, the impact sensor 131 is a tri-axial accelerometer. The tri-axial accelerometer can sense acceleration changes of the electronic device 100. If the electronic device 100 is impacted or dropped, the processor 12 calculates an impact force according to the equation F=ma. “F” is the impact force, “m” is the mass of the electronic device 100, and “a” is the acceleration of the electronic device 100 caused by the external force. In at least one embodiment, the impact sensor 131 further includes a gyroscope for determining a direction of the external force. In another embodiment, the impact sensor 131 is a collision sensor for detecting whether the electronic device 100 is impacted or dropped, and a force of the collision is detected by the collision sensor. In other embodiments, the impact sensor 131 can be omitted.

The flood sensor 132 detects whether the electronic device 100 contacts water. When the flood sensor 132 detects that the electronic device 100 contacts water, the flood sensor 132 sends out a corresponding signal. In at least one embodiment, the flood sensor 132 is a contact-type flood sensor. The flood sensor 132 utilizes liquid conductivity and a pull-up resistor circuit design. When the electronic device 100 is not contacted with water, a circuit of the pull-up resistor is open, and a voltage of the pull-up resistor is at a high level. When the electronic device 100 contacts water, because of the conductivity of water, the pull-up resistor is grounded, and the voltage of the pull-up resistor is at a low level. When the flood sensor 132 senses that the voltage of the pull-up resistor is at a low level, the flood sensor 132 determines that the electronic device 100 has contacted water and generates the corresponding signal. In another embodiment, the flood sensor 132 includes two electrodes. When the electronic device 100 does not contact water, the two electrodes are isolated by air, and a circuit between the two electrodes is open. When the electronic device 100 contacts water, the two electrodes are electrically coupled together, and the flood sensor 132 determines that the electronic device 100 has contacted water because of disruption of the circuit. The flood sensor 132 sends out a corresponding signal according to whether the electronic device 100 contacts water or doesn't contact water. In at least one embodiment, the electronic device 100 is a mobile phone, which includes an audio receiver (not shown). The flood sensor 132 can be positioned within a casing of the electronic device 100 adjacent to the audio receiver and share a through hole with the audio receiver. In this way, when the electronic device 100 enters water, the flood sensor 132 senses the water entered through the through hole of the audio receiver. In other embodiments, the flood sensor 132 is positioned on an outer surface of the electronic device 100. In other embodiments, the flood sensor 132 is positioned within the casing of the electronic device 100 adjacent to a corresponding opening of the electronic device 100.

The pressure sensor 133 senses a water pressure at a location of the electronic device 100 in the water to allow the processor 12 to calculate a depth value of the electronic device 100 in the water. The processor 12 calculates the depth value according to the formula h=P/pg. “h” is the depth value, “P” is the pressure of the water sensed by the pressure sensor 133, “p” is the density of the liquid, and “g” is the standard Earth gravity (9.8 N/kg). In at least one embodiment, the pressure sensor 133 is a micro-pore water pressure sensor. In other embodiments, the pressure sensor 133 can be other types of pressure sensors.

The temperature sensor 134 senses a temperature of the water. In at least one embodiment, the pressure sensor 133 and the temperature sensor 134 can be arranged inside the casing of the electronic device 100 adjacent to a speaker of the electronic device 100.

In other embodiments, the sensing unit 13 can only include the flood sensor 132 and the pressure sensor 133, or only include the flood sensor 132 and the temperature sensor 134.

In other embodiments, the sensing unit 13 can include other sensors.

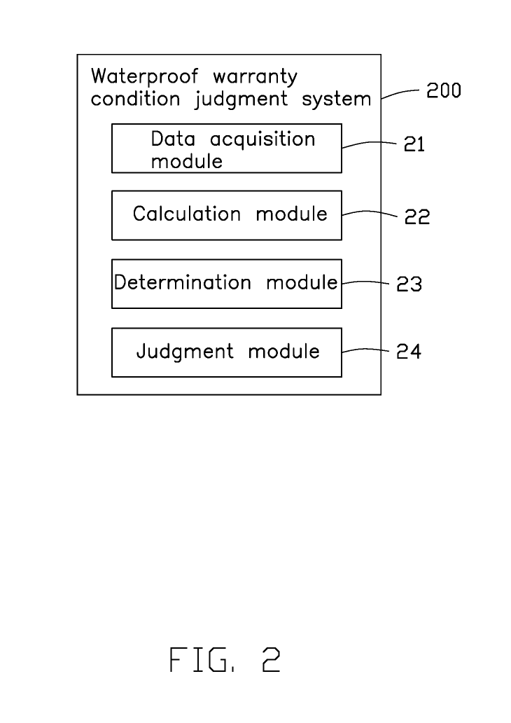

FIG. 2 illustrates a diagram of function modules of a waterproof warranty condition judgment system 200. The modules can include a data acquisition module 21, a calculation module 22, a determination module 23, and a judgment module 24. The modules 21-24 can include one or more software programs in the form of computerized codes stored in the storage 11. The computerized codes can include instructions executed by the processor 12 to provide functions for the modules 21-24.

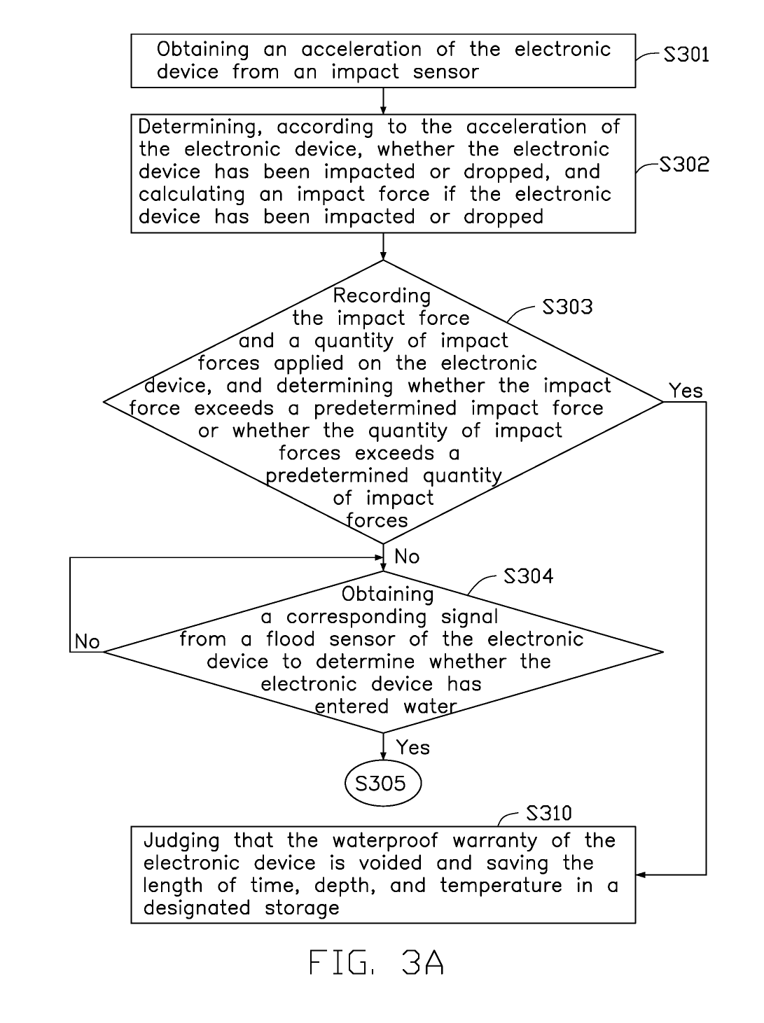

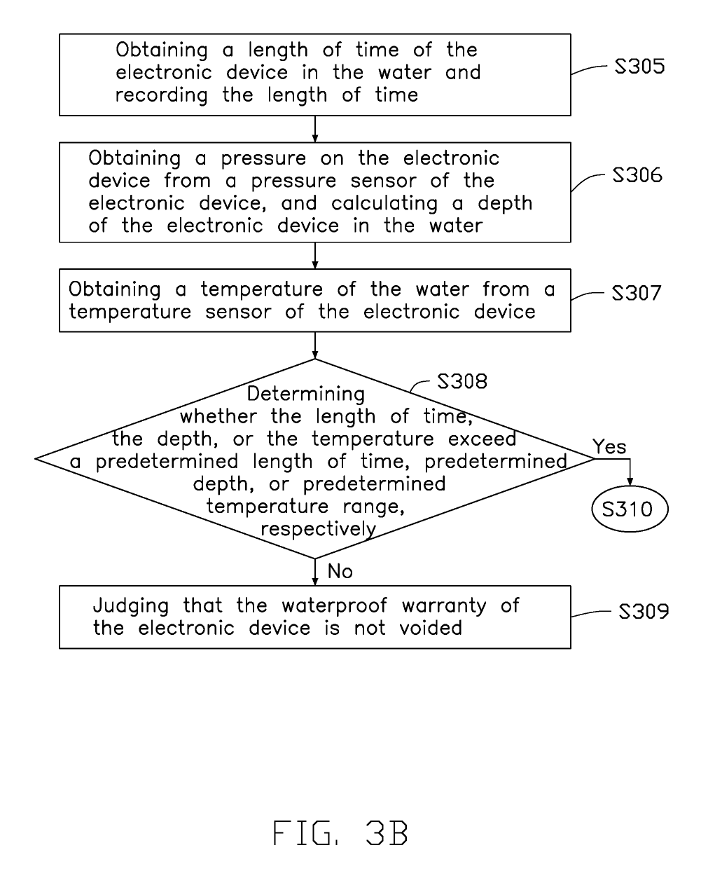

FIG. 3 illustrates a flowchart of an exemplary method for determining whether a waterproof warranty of an electronic device is voided. The example method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 301.

At block 301, the data acquisition module 21 obtains an acceleration of the electronic device 100 from the impact sensor 131.

At block 302, the calculation module 22 determines, according to the acceleration of the electronic device 100, whether the electronic device 100 has been impacted or dropped, and calculates an impact force if the electronic device 100 has been impacted or dropped. The calculation module 22 calculates the impact force according to the equation F=ma. “F” is the impact force, “m” is the mass of the electronic device 100, and “a” is the acceleration of the electronic device 100 caused by the external force. The mass of the electronic device 100 can be prestored in the storage 11.

At block 303, the determination module 23 records the impact force and a quantity of impact forces applied on the electronic device 100, and determines whether the impact force exceeds a predetermined impact force or whether the quantity of impact forces exceeds a predetermined quantity of impact forces. If the predetermined impact force and/or the predetermined quantity of impact forces are/is exceeded, block 310 is implemented. Otherwise, block 304 is implemented. For example, the predetermined quantity of impact forces is five, and the predetermined impact force is 10 Newtons.

At block 304, the data acquisition module 21 obtains the corresponding signal from the flood sensor 132 to determine whether the electronic device has entered water. If the electronic device has entered water, block 305 is implemented. Otherwise, block 304 is repeated. When the flood sensor 132 detects that the electronic device 100 contacts water, the flood sensor 132 sends out the corresponding signal, and the data acquisition module 21 determines that the electronic device 100 has entered water.

At block 305, the data acquisition module 21 obtains a length of time of the electronic device 100 in the water and records the length of time.

At block 306, the data acquisition module 21 obtains the pressure on the electronic device 100 from the pressure sensor 133, and calculates the depth value of the electronic device 100 in the water. The data acquisition module 21 calculates the depth value according to the formula h=P/pg. “h” is the depth value, “P” is the pressure of the water sensed by the pressure sensor 133, “p” is the density of the liquid, and “g” is the standard Earth gravity (9.8 N/kg).

At block 307, the data acquisition module 21 obtains the temperature of the water from the temperature sensor 134.

At block 308, the determination module 23 determines whether the length of time, the depth, or the temperature exceed a predetermined length of time, predetermined depth, or predetermined temperature range, respectively. If the predetermined length of time, predetermined depth, and predetermined temperature range are all not exceeded, block 309 is implemented. If any of the predetermined length of time, predetermined depth, or predetermined temperature range is exceeded, block 310 is implemented.

At block 309, the judging module 24 judges that the waterproof warranty of the electronic device 100 is not voided.

At block 310, the judging module 24 judges that the waterproof warranty of the electronic device 100 is voided and saves the length of time, depth, and temperature in a designated storage. The designated storage is inaccessible and cannot be altered or deleted by a user. In this way, a manufacturer of the electronic device 100 can know that the waterproof warranty is voided. In at least one embodiment, the length of time, depth, and temperature are saved in a NAND storage.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An electronic device comprising:
a sensing unit configured to detect whether the electronic device has entered a liquid, and upon sensing that the electronic device has entered a liquid, sense a plurality of environmental parameters of the liquid;
a storage; and
a processor configured to:
obtain the plurality of environmental parameters of the liquid from the sensing unit;
determine whether any of the plurality of environmental parameters exceed a predetermined value; and
judge, when any of the plurality of environmental parameters exceed the predetermined value, that a waterproof warranty on the electronic device is voided.

2. The electronic device of claim 1, wherein the plurality of environmental parameters comprises a length of time of the electronic device in the liquid; the sensing unit comprises a flood sensor for determining whether the electronic device enters a liquid; when the flood sensor determines that the electronic device enters a liquid, the processor records a time of entering the liquid and a length of time of remaining in the liquid; the processor determines whether the length of time of remaining in the liquid exceeds a predetermined time duration; upon determining that the length of time exceeds the predetermined time duration, the processor judges that the waterproof warranty is voided.

3. The electronic device of claim 1, wherein the plurality of environmental parameters comprises a depth value of a position of the electronic device in the liquid; the sensing unit comprises a pressure sensor for sensing a pressure on the electronic device; the processor calculates the depth value according to the formula h=P/pg, wherein “h” is the depth value, “P” is the pressure of the liquid sensed by the pressure sensor, “p” is the density of the liquid, and “g” is the standard Earth gravity; the processor determines whether the depth value exceeds a predetermined depth value; upon determining that the depth value exceeds the predetermined depth value, the processor judges that the waterproof warranty is voided.

4. The electronic device of claim 1, wherein the plurality of environmental parameters comprises a temperature; the sensing unit comprises a temperature sensor for sensing a temperature of the liquid; the processor determines whether the temperature is outside a range of temperatures; upon determining that the temperature is outside the range of temperature, the processor judges that the waterproof warranty is voided.

5. The electronic device of claim 1, wherein the sensing unit comprises an impact sensor for sensing an acceleration of the electronic device and determining, according to the sensed acceleration, whether an outside force impacts the electronic device; the equation F=ma is used to calculate an impact force wherein “F” is the impact force, “m” is the mass of the electronic device, and “a” is the acceleration sensed by the impact sensor; the processor determines whether the impact force exceeds a predetermined impact force; upon determining that the impact force exceeds the predetermined impact force, the processor judges that the waterproof warranty is voided; upon determining that the impact force does not exceed the predetermined impact force, the processor determines whether the electronic device has entered a liquid.

6. The electronic device of claim 1, wherein when the processor judges that the waterproof warranty is voided, the processor saves the environmental parameters in a designated storage, wherein the designated storage is inaccessible and cannot be altered or deleted by a user.

7. A waterproof warranty determining method implemented in an electronic device, the electronic device comprising a sensing unit configured to detect whether the electronic device has entered a liquid, and upon sensing that the electronic device has entered a liquid, sense a plurality of environmental parameters of the liquid, the method comprising:
obtaining the plurality of environmental parameters of the liquid from the sensing unit;
determining whether any of the plurality of environmental parameters exceed a predetermined value; and
judging, when any of the plurality of environmental parameters exceed the predetermined value, that a waterproof warranty on the electronic device is voided.

8. The waterproof warranty determining method of claim 7, wherein the plurality of parameters comprises a length of time of remaining in the liquid, a depth value of the electronic device in the liquid, and a temperature of the liquid, and the method further comprises:
determining whether the electronic device enters a liquid;
upon determining that the electronic device enters a liquid, recording a time of entering the liquid and the length of time of remaining in the liquid;
sensing a pressure on the electronic device and calculating the depth value of the electronic device in the liquid according to a density of the liquid and a sensed pressure on the electronic device; and
sensing the temperature of the liquid.

9. The waterproof warranty determining method of claim 7, wherein before obtaining the environmental parameters, the method comprises:
sensing an acceleration of the electronic device;
determining, according to the sensed acceleration, whether an outside force impacts the electronic device, and upon determining that an outside force has impacted the electronic device, calculating an impact force of the outside force;
recording the impact force and a quantity of impact forces on the electronic device, and determining whether the impact force or the quantity of impact forces on the electronic device exceeds a predetermined impact force or predetermined quantity of impact forces, upon determining that the impact force and/or the quantity of impact forces exceeds a predetermined impact force/quantity of impact forces, judging that the waterproof warranty is voided.

10. The waterproof warranty determining method of claim 7, wherein upon determining that the warranty is voided, saving the environmental parameters in a designated storage, wherein the designated storage is inaccessible and cannot be altered or deleted by a user.

11. A non-transitory storage medium having stored thereon instructions that, when executed by at least one processor of an electronic device, cause the at least one processor to execute instructions of a method for judging whether a waterproof warranty of the electronic device is voided, the electronic device comprising a sensing unit configured to detect whether the electronic device has entered a liquid, and upon sensing that the electronic device has entered a liquid, sense a plurality of environmental parameters of the liquid, the method comprising:
obtaining a plurality of environmental parameters of the liquid from the sensing unit;
determining whether any of the plurality of environmental parameters exceed a predetermined value; and
judging, when any of the plurality of environmental parameters exceed the predetermined value, that the waterproof warranty on the electronic device is voided.

12. The non-transitory storage medium of claim 11, wherein the plurality of parameters comprises a length of time of remaining in the liquid, a depth value of the electronic device in the liquid, and a temperature of the liquid, and the method further comprises:
determining whether the electronic device enters a liquid;
upon determining that the electronic device enters a liquid, recording a time of entering the liquid and the length of time of remaining in the liquid;
sensing a pressure on the electronic device and calculating the depth value of the electronic device in the liquid according to a density of the liquid and a sensed pressure on the electronic device; and
sensing the temperature of the liquid.

13. The non-transitory storage medium of claim 11, wherein before obtaining the environmental parameters, the method comprises:
sensing an acceleration of the electronic device;
determining, according to the sensed acceleration, whether an outside force impacts the electronic device, and upon determining that an outside force has impacted the electronic device, calculating an impact force of the outside force;
recording the impact force and a quantity of impact forces on the electronic device, and determining whether the impact force or the quantity of impact forces on the electronic device exceeds a predetermined impact force or predetermined quantity of impact forces, upon determining that the impact force and/or the quantity of impact forces exceeds a predetermined impact force/quantity of impact forces, judging that the waterproof warranty is voided.

14. The non-transitory storage medium of claim 11, wherein upon determining that the waterproof warranty is voided, saving the environmental parameters in a designated storage, wherein the designated storage is inaccessible and cannot be altered or deleted by a user.
